(19) United States
(12) Patent Application Publication
(10) Pub. No.: US 2008/0075065 A1
(43) Pub. Date: Mar. 27, 2008

(54) Wireless VoIP headset with call origination capability

(75) Inventors: Edward L. Reuss, Santa Cruz, CA (US); William O. Brown, Santa Cruz, CA (US); Cristian C. Filimon, San Jose, CA (US); Alan Altmann, Palo Alto, CA (US); Rick Giles, San Jose, CA (US)

Correspondence Address: PLANTRONICS, INC., 345 ENCINAL STREET, P.O. BOX 635, SANTA CRUZ, CA, 95060-0635, US

(73) Assignee: Plantronics, Inc.

(21) Appl. No.: 11/522,195

(22) Filed: Sep. 15, 2006

(51) Int. Cl. H04L 12/66

(52) U.S. Cl. 370/352

(57) ABSTRACT

Systems and methods for a wireless VoIP headset. A wireless VoIP headset including a speaker, microphone, controller for processing a digital audio signal to generate IP packets, and an IEEE 802.11 transceiver. The wireless VoIP headset includes a computer readable memory storing instructions that when executed by the controller cause the wireless VoIP headset to perform a method for originating a call. The method includes receiving a spoken name or number from a user at the microphone, interpreting the spoken name or number using embedded or server based voice recognition, comparing the spoken name or number to a directory stored in the computer readable memory, and generating a call origination request message. The directory may also be stored on an adjunct computing device.

### BACKGROUND OF THE INVENTION

The use of Voice over Internet Protocol (VoIP) is a fast growing trend in the telephony industry, displacing circuit switch analog and digital telecom systems. Voice over Internet Protocol transmits voice over a data network utilizing Internet Protocol (IP) data packets. In VoIP, analog speech signals received from an audio source are digitized, compressed, and translated into IP packets for transmission over an IP network such as the Internet. Some benefits of VoIP include cost savings and new applications. For example, VoIP can be used to bypass the toll structure imposed by the service providers that operate the PSTN or combined with other Internet services such as embedding voice mail messages into user e-mail. Typically, in a business environment a VoIP phone connects to the corporate data network through an Ethernet connection, either wired (IEEE 802.3) or wireless (IEEE 802.11).

The proliferation of IEEE 802.11 WiFi networks extends the reach of VoIP solutions into wireless edge devices. In the prior art, wireless VoIP handsets are examples of wireless edge devices that have been developed. However, such devices are neither handsfree or discreet. Most wireless VoIP telephones are rather large, having either a handset form factor or being a laptop based softphone. In the prior art, IEEE 802.11 based headsets have been demonstrated, but lack the ability to originate calls. Thus, they are not a true telephone and have limited utility.

As a result, there is a need for improved methods and apparatuses for wireless VoIP telephone devices.

### BRIEF DESCRIPTION OF THE DRAWINGS

The present invention will be readily understood by the following detailed description in conjunction with the accompanying drawings, wherein like reference numerals designate like structural elements.

FIG. 1 illustrates a simplified block diagram of a wireless VoIP headset in one example of the invention.

FIG. 2 illustrates a system view of a wireless VoIP headset in use in one example of the invention.

FIG. 3 illustrates a system view of a wireless VoIP headset in use with server based voice recognition in a further example of the invention.

FIG. 4 illustrates a system view of a wireless VoIP headset in use with an adjunct computing device in a further example of the invention.

### DESCRIPTION OF SPECIFIC EMBODIMENTS

Methods and apparatuses for wireless VoIP telephones in a headset form factor are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

The invention relates to the general field of Voice over Internet Protocol and more specifically, to a wireless VoIP telephone device in the form factor of a headset. This description describes a method and apparatus for a wireless VoIP headset with call origination functionality, allowing complete handsfree communication. In one example, the wireless VoIP headset allows for call origination using embedded voice recognition and self-contained directory. In a further example, the wireless VoIP headset allows for call origination by automatically originating a call to a voice recognition server. In a further example, the wireless VoIP headset allows for call origination by receiving call data from an associated wireless adjunct device.

The wireless VoIP headset telephone can allow handsfree communication throughout an enterprise wherever there is wireless LAN access. Unlike point-to-point devices, such as DECT based headsets, there are no range limitations. By incorporating call origination capabilities, the headset device becomes a full telephone rather than a simple peripheral to a desk or mobile phone. The wireless VoIP headset has an IP address, either fixed or dynamically assigned using a protocol such as DHCP, and resides on the packet network, potentially having access to the Internet with all its resources, enabling future applications that draw on the information available on the Internet. Example use cases include the ability to originate and receive phone calls discreetly through local hot spots or other Wi-Fi enabled locations. Multimedia versions of the VoIP headset telephone can incorporate streaming audio access from the Internet or local computer.

In one example of the invention, a wireless VoIP headset includes a speaker, a microphone, an IEEE 802.11 transceiver, and a codec for converting an analog audio signal to a digital audio signal and encoding the digital audio signal. The codec also decodes a receive digital audio signal for output to the speaker. The headset further includes a controller which processes the digital audio signal to generate IP packets and implements a VoIP call control protocol. The headset includes a computer readable memory storing instructions that when executed by the controller cause the wireless VoIP headset to perform a method for originating a VoIP call. The method includes, receiving a spoken name or number from a user at the microphone, interpreting the spoken name or number using voice recognition, comparing the spoken name or number to a directory stored in the computer readable memory, and generating a VoIP call origination request message.

In one example of the invention, a wireless VoIP headset includes a speaker, a microphone for receiving speech energy from a near end user to generate an analog audio signal, and a codec for converting the analog audio signal to a digital audio signal and encoding the digital audio signal. The codec also decodes a receive digital audio signal for output to the speaker. The headset also includes an IEEE 802.11 transceiver and a controller for processing the digital audio signal to generate IP packets and implementing a VoIP call control protocol. The headset includes a computer readable memory storing instructions that when executed by the controller cause the wireless VoIP headset to perform a method for originating a call. The method includes automatically connecting to a voice recognition server upon activation of the wireless VoIP headset by a user.

In one example of the invention, a VoIP telephone system includes a computing device and a wireless VoIP headset. The computing device includes a memory storing a name and phone number directory and a first IEEE 802.11 transceiver. The wireless VoIP headset includes a second IEEE 802.11 transceiver, a speaker, and a microphone for receiving speech energy from a near end user to generate an analog audio signal. A codec converts the analog audio signal to a digital audio signal and encodes the digital audio signal. The codec also decodes a receive digital audio signal for output to the speaker. The headset further includes a controller for processing the digital audio signal to generate IP packets and implementing a VoIP call control protocol. The headset includes a computer readable memory storing instructions that when executed by the controller cause the wireless VoIP headset to perform a method for originating a call. The method includes receiving a user directory selection from the computing device through the first IEEE 802.11 transceiver to the second IEEE 802.11 transceiver, and generating a VoIP call origination request message responsive to the user directory selection.

In one example of the invention, a method for initiating a VoIP telephone call includes providing a wireless VoIP headset. The wireless VoIP headset includes a speaker, a microphone, a codec, a controller, a first memory, and a first IEEE 802.11 transceiver for wireless communications with an IEEE 802.11 access point. The method further includes providing a computing device including a second memory storing a name and phone number directory, and a second IEEE 802.11 transceiver for wireless communications with an IEEE 802.11 access point. The method includes receiving a user selection at the computing device from the name and phone number directory, transmitting the user selection from the computing device to the wireless VoIP headset via the IEEE 802.11 access point, and generating a VoIP call origination request message at the wireless VoIP headset responsive to the user selection.

In one example of the invention, a method for initiating a VoIP telephone call includes providing a wireless VoIP headset. The wireless VoIP headset includes a speaker, a microphone, a codec, a controller, a first memory, and a first IEEE 802.11 transceiver for wireless communications with an IEEE 802.11 access point. The method includes providing a computing device having a second memory storing a name and phone number directory, and a wired IEEE 802.3 network connection to the IEEE 802.11 access point. The method further includes receiving a user selection at the computing device from the name and phone number directory, transmitting the user selection from the computing device to the wireless VoIP headset via the IEEE 802.11 access point, and generating a VoIP call origination request message at the wireless VoIP headset responsive to the user selection.

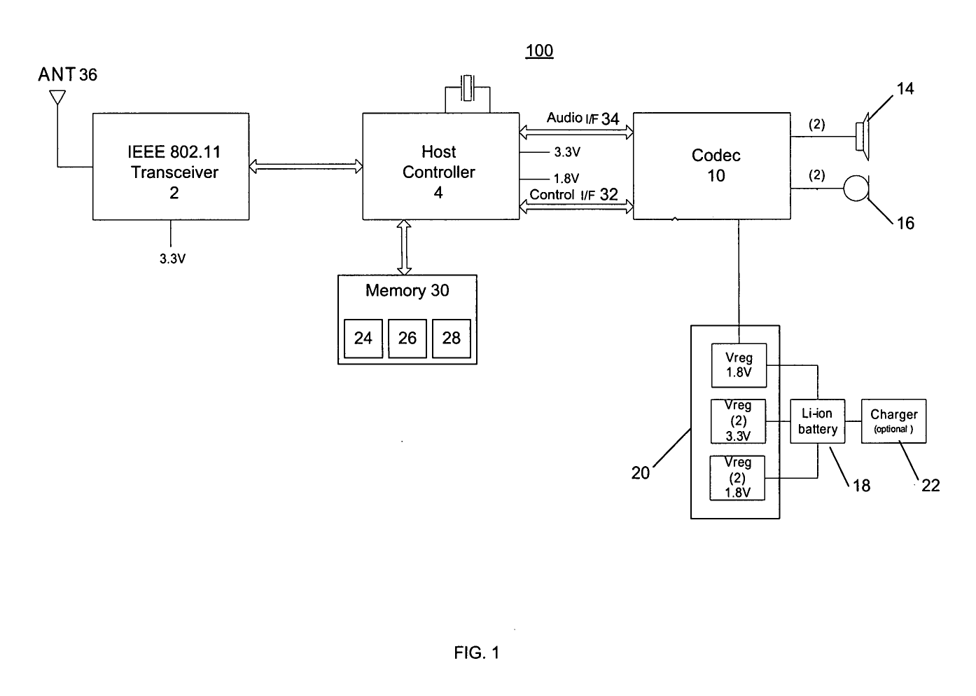

FIG. 1 illustrates a simplified block diagram of a wireless VoIP headset 100 in one example of the invention. VoIP headset 100 is operable as a VoIP telephone with call origination capability. Wireless VoIP headset 100 includes an IEEE 802.11 radio transceiver 2 along with an associated host controller 4. Host controller 4 interfaces with memory 30. For example, memory 30 may include a combination of non-volatile and volatile memory, including flash memory and SDRAM.

Wireless VoIP headset 100 has a speaker 14 and a microphone 16. A codec 10 includes an analog-to-digital (A/D) converter for converting the signals received from microphone 16 to digital form. The digital signals are encoded by codec 10. A control interface 32 transfers data between host controller 4 and codec 10. Codec 10 also includes a D/A converter for converting digital audio for playback over speaker 14.

The output of codec 10 is provided to host controller 4 through audio interface 34. Additionally, codec 10 receives the output of host controller 4 through audio interface 34. In one example of the invention, codec 10 encodes the digital signals received from the A/D converter using pulse code modulation (PCM) and transfers them to host controller 4. For example, 16 bit, 8 kSamples/sec encoding may be used for telephony or 16 bit, 16 kSamples/sec encoding may be used for wideband applications. Other examples of VoIP audio codec formats include, without limitation, linear PCM and iLBC, and ITU-T recommendations G.711. G.729, G.723, G.726, and G.722.

A digital signal processor (DSP) may perform a variety of audio signal processing functions known in the art to improve the sound quality of the encoded audio received from codec 10 and to improve voice recognition accuracy or sound quality of the transmit voice signal. The DSP may also perform processing on a receive signal prior to output to speaker 14 through codec 10. Such processing may include echo cancellation, noise reduction, and multiband compression. Noise reduction may be employed to mitigate the effects of various types of noise in the system. A wide variety of techniques may be used which separate the desirable signal, i.e., speech from the person currently talking, from various sources of interference, e.g., peripheral noise, far end-speech, etc. Such techniques may include the use of, for example, Wiener filters, noise gates, spectral subtraction, and other techniques known in the art.

Host controller 4 controls the operation of wireless VoIP headset 100 and processes the PCM audio to form data packets for wireless transmission and reception of packets over an IEEE 802.11 network using an IEEE 802.11 transceiver 2 and antenna 36. Host controller 4 is programmed with associated computer program instructions to perform the functionalities described herein.

The ITU-T standardizes PCM, ADPCM, and CELP coding schemes in its G-series recommendations. Example voice coding standards for telephony and packet voice include G.711, G.722, G.723, G.726, and G.729. G.711 describes 64 kbps PCM voice coding. G.726 describes ADPCM coding at 16, 24, 32, and 40 kbps. G.729 describes CELP compression that enables voice to be coded into 8 kbps streams. The number of speech samples sent in one packet can be varied. For example, G.729 coding generates a speech sample every 10 ms. The Cisco IOS VoIP product places two speech samples within one packet. In a further example of the invention, four or more speech samples may be placed in each packet.

In one example of the invention, a standards based VoIP telephone stack and a standards based IEEE 802.11 software protocol stack are utilized. In one example, wireless VoIP headset 100 utilizes a Linux operating system with open technology VoIP software. In one example, a multi-threaded VoIP application is used which utilizes a link manager which supplements IEEE 802.11 driver service for roaming from AP to AP, a SIP stack, and an RTP stack.

Host controller 4 monitors the activity of the wireless VoIP headset 100 and receives input from various user interface components including, for example, a call initiate, answer, and terminate button, a volume encoder, a mute circuit/switch, and an on/off circuit. Host controller 4 also has input/output interfaces including, for example visual indicators. The headset user interface includes a means to be alerted of an incoming call and a means to answer the call. The headset user interface includes a means to originate a phone call, as described in further detail below.

As discussed above, wireless VoIP headset 100 is configured to receive and transmit digital data or packets over a wireless IEEE 802.11 interface. Packets are received and transmitted using a IEEE 802.11 transceiver chip set. The wireless VoIP headset 100 includes a suitable antenna 36 for transmitting and receiving the packets.

Host controller 4 is operable to perform functions necessary to implement VoIP. For example, host controller 4 operates as a system control unit providing call control (such as H.225 and H.245 call control), messaging, capability exchange, and signaling of commands for proper operation of the VoIP functions of the wireless VoIP headset 100. In one example of the invention, host controller 4 implements Session Initiation Protocol (SIP). SIP is an application-layer signaling protocol over IP networks designed for creating and terminating sessions such as phone calls.

In a further example of the invention, host controller 4 implements the H.323 International Telecommunication Union Telecommunication Standardization Sector (ITU-T) specification for transmitting audio, video, and data across an Internet Protocol network, including the Internet. H.323 defines a set of call control, channel setup, and codec specifications for transmitting real time audio and video over packet data networks. In an H.323 network, the IP network may connect to a PSTN via a H.323 gateway, which serves to interface between the packet based IP network and other networks such as the PSTN. In furthers examples, other VoIP call-control protocols may be used. Such VoIP call control protocols include Simple Gateway Control Protocol (SGCP) and Internet Protocol Device Control (IPDC).

A real time transport protocol (RTP) header may be added. VoIP is carried out with an RTP/UDP/IP packet header. An IP header includes a source address field and a destination address field. A UDP header includes four fields: source port, length, destination port, and checksum. An RTP header includes a sequence number field and timestamp field. RTP is the standard for transmitting delay sensitive traffic such as audio across packet-based networks. RTP resides on top of UDP and IP, giving receiving stations information that is not available in the connectionless UDP/IP streams. Such information includes sequence information and timestamping. Sequencing information is included in the RTP header to determine whether the packets are arriving in order. Time-stamping information is included in the RTP header to determine when the enclosed data should be replayed to the headset speaker. A data buffer, commonly referred to as a “jitter buffer”, is used to store the received data until the RTP clock reaches the time indicated in the timestamp.

Wireless VoIP headset 100 is capable of call origination. To originate a call it is necessary to generate a destination phone number and an origination request. In one example, wireless VoIP headset 100 utilizes embedded voice recognition for call origination. A self contained directory 28 associating names and phone numbers is stored in memory 30, along with a voice recognition engine 24 and call origination application 26. This allows the destination to be determined from spoken dial-by-number recognition or by dial-by-name or other means (e.g., operator, reception, help desk) drawing on a self contained directory 28. This directory may be loaded into the headset memory 30 either over the air or through other synchronization means, perhaps to the user's Microsoft Outlook address book on his/her computer. The directory may contain SIP URIs which are used directly to originate calls. Alternatively, the directory may contain phone numbers which are used to construct a SIP URI using the method described below. Spoken names or numbers are interpreted by the voice recognition engine 24 at call origination application 26 and the result used to generate an origination request message using the chosen VoIP signaling mechanism such as SIP.

In SIP, the call origination request message is an INVITE request sent by the SIP user agent wireless VoIP headset 100. The INVITE request includes a To: field containing a display name and a destination SIP address (also referred to as the SIP URI (Uniform Resource Identifier)) of the intended recipient of the call (referred to herein as the “callee’). The SIP address is identified by the format user@host. The user portion of the address can be a user name or telephone number and the host portion can be a domain name or network address. For example, the To: field may be:

To: user3<sip:user3@server3.com>

or

To: user4<sip:8315252222@server4.com

where “user 3” and “user 4” are the user names and “sip:user3@server3.com” and “sip:8315252222@server4.com” are the SIP addresses of the callee. A user SIP address is matched with each name and telephone number in self contained directory 28. In one example, a user SIP address may correspond to an existing phone number which has been translated to an SIP address using ENUM (Telephone Number Mapping) or Distributed Universal Number Discovery (DUNDi) protocols.

The INVITE request is sent from the wireless VoIP headset 100 to a proxy server, which forwards the INVITE request to another proxy server or to the recipient (the callee) itself. The precise IP address of the callee may not be known by the SIP user agent at the time the INVITE request is generated. The proxy server utilizes a registrar server to identify the precise IP address of the callee, which has been registered by the callee to the registrar server and stored in a location server along with the callee user name. Upon receipt of the INVITE request, if the callee accepts the call, an OK response message is sent by the callee phone back towards VoIP headset 100. The OK response message includes the exact IP address of the callee phone so that VoIP headset 100 can communicate directly without the need for a proxy server. VoIP headset 100 then sends an ACK message directly to the callee phone to confirm the setup of the call.

Power is provided to the components of wireless VoIP headset 100 using a rechargeable battery such as Lithium ion battery 18, which is used to provide a regulated voltage supply 20 at various levels as needed by the components. For example, regulated voltage supply 20 may provide a 1.8V and 3.3V supply. A charging circuit 22 is used to provide charging power to battery 18. The components illustrated in FIG. 1 are packaged in a headset form factor.

Since the headset 100 includes a processor running an Internet Protocol stack and an IP address, it is also capable of supporting a web page server. The web pages that it serves can include headset control functions, such as a telephone directory, volume control, audio filtering, signal processing control, and specific set up and provisioning information such as the IP address of the SIP server. The user can access these web pages through the use of a standard web browser which supports the Hyper-Text Markup Language (HTML) or the eXtensible Markup Language (XML) to control the operation of the headset.

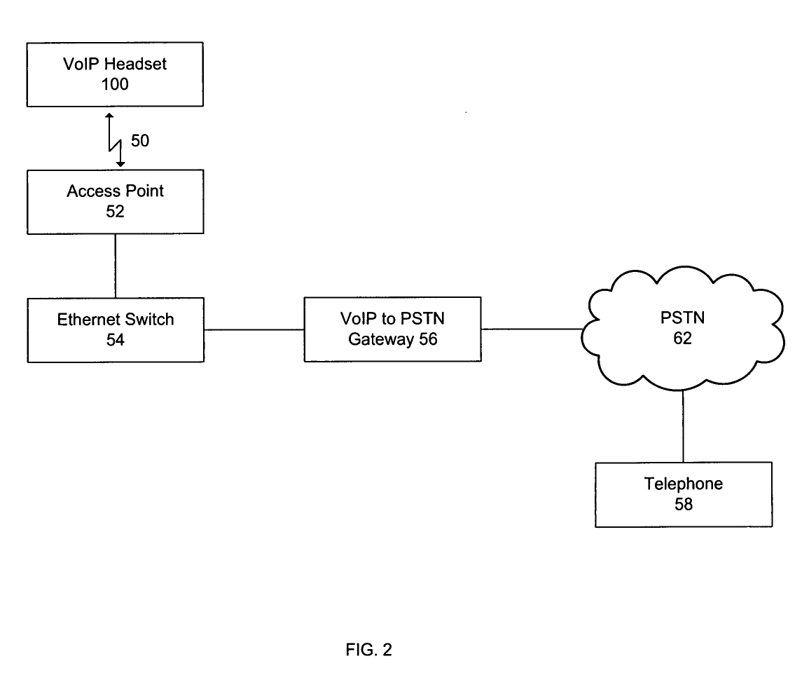

FIG. 2 illustrates a system view of a wireless VoIP headset 100 in use in one example of the invention. Wireless VoIP headset 100 and an IEEE 802.11 access point 52 communicate over an IEEE 802.11 wireless link 50. The use of the term IEEE 802.11 herein is meant to address the entire family of IEEE 802.11 standards, including IEEE 802.11b, IEEE 802.11g, and future standards such as IEEE 802.11n. Access point 52 connects to an Ethernet LAN via Ethernet switch 54. Ethernet switch 54 connects to the PSTN 62 via a VoIP to PSTN gateway 56 for communication with a telephone 58.

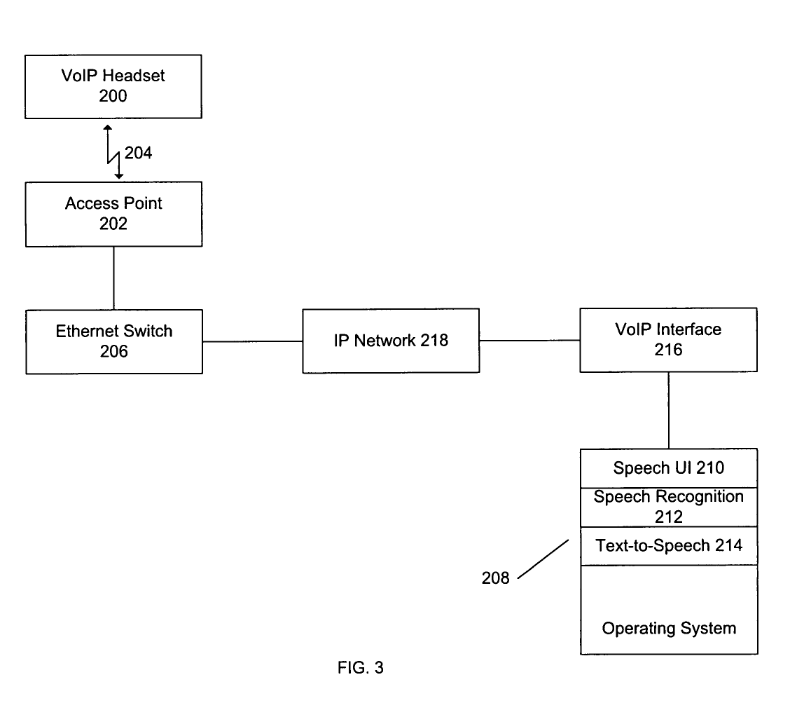

FIG. 3 illustrates a system view of a wireless VoIP headset 200 in use with server based voice recognition in a further example of the invention. Wireless VoIP headset 200 and an IEEE 802.11 access point 202 communicate over an IEEE 802.11 wireless link 204. IEEE 802.11 access point 202 is coupled to an Ethernet switch 206. Ethernet switch 206 is coupled to an IP network 218, which connects to a VoIP interface 216. VoIP interface 216 connects to a voice recognition server 208. Voice recognition server 208 includes a speech user interface application 210, speech recognition application 212, and text-to-speech application 214. Voice recognition server 208 allows a user to place telephone calls over either the Internet or a PSTN.

In operation, wireless VoIP headset 200 is configured to automatically connect to voice recognition server 208 upon a designated user interface action. For example, pushing a button on the wireless VoIP headset 200 would originate a call and direct it to the voice recognition server 208. For example, when the hook switch on the wireless VoIP headset 200 is pressed, a SIP request command to set up a VoIP phone call is sent from the wireless VoIP headset 200 to the VoIP interface 216. This SIP command carries the phone number for the voice recognition server 208. The SIP URI or the IP address is pre-stored in the headset. From this point forward, the VoIP Interface 216 directs the VoIP data packets to voice recognition server 208 and vice-versa. Voice commands received at the wireless VoIP headset 200 and transmitted to voice recognition server 208 are then used to complete the call.

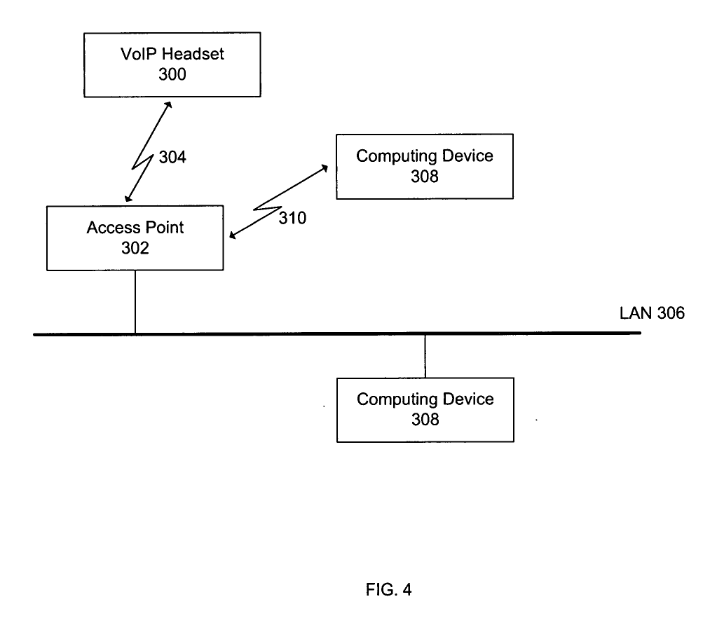

FIG. 4 illustrates a system view of a wireless VoIP headset 300 in use with an adjunct computing device 308 in a further example of the invention. Wireless VoIP headset 300 is the same as wireless VoIP headset 100 except that it does not utilize a self embedded directory or voice recognition in the call origination process. Wireless VoIP headset 300 and an IEEE 802.11 access point 302 communicate over an IEEE 802.11 wireless link 304. IEEE 802.11 access point 302 is coupled to a LAN 306. An adjunct computing device 308 includes an IEEE 802.11 transceiver and communicates with IEEE 802.11 access point 302 over an IEEE 802.11 wireless link 310. For example, computing device 308 is a personal digital assistant storing a directory of names and phone numbers. In a further example, computing device 308 is connected to the IEEE 802.11 access point 302 via a wired 802.3 Ethernet network. For example, computing device 308 may be a desktop PC.

In operation, adjunct computing device 308 is associated with the wireless VoIP headset 300 and communicates directly with it through the IP network. For example, a name and phone number directory stored on the adjunct computing device 308 is used by a user of the computing device 308 to select a phone call destination. The associated selected phone number or SIP URI is transmitted to wireless VoIP headset 300 over the IP network. The headset originates the call by initiating a call originate request message including the associated phone number or SIP URI, through the VoIP protocol.

The various examples described above are provided by way of illustration only and should not be construed to limit the invention. Based on the above discussion and illustrations, those skilled in the art will readily recognize that various modifications and changes may be made to the present invention without strictly following the exemplary embodiments and applications illustrated and described herein. Such changes may include, but are not necessarily limited to: number, placement, and functions performed by the user interface on the wireless VoIP headset; wireless communication technologies; standards to perform the VoIP call setup, signaling, and control. Furthermore, the functionality associated with any blocks described above may be centralized or distributed. It is also understood that one or more blocks of the wireless VoIP headset may be performed by hardware, firmware or software, or some combinations thereof. Such modifications and changes do not depart from the true spirit and scope of the present invention that is set forth in the following claims.

Those skilled in the art will appreciate that the reference to packets as used herein is intended to encompass any type of packet, including but not limited to Internet Protocol (IP) packets, Ethernet frames, Asynchronous Transfer Mode (ATM) cells and other types of datagrams. Similarly, the terms “VoIP” and “VoIP phone” is used in the generic sense to include any “voice-over-packet” technique or device, without limitation to a specific standard.

While the exemplary embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may be amended, with each claim being expressly incorporated into this Description of Specific Embodiments as an embodiment of the invention.

What is claimed is:

1. A wireless VoIP headset comprising:
a speaker;
a microphone for receiving speech energy from a near end user to generate an analog audio signal;
a codec for converting the analog audio signal to a digital audio signal and encoding the digital audio signal, wherein the codec also decodes a receive digital audio signal for output to the speaker;
a controller for processing the digital audio signal to generate IP packets and implementing a VoIP call control protocol;
an IEEE 802.11 transceiver; and
a computer readable memory storing instructions that when executed by the controller cause the wireless VoIP headset to perform a method for originating a VoIP call comprising:
receiving a spoken name or number from a user at the microphone;
interpreting the spoken name or number using voice recognition;
comparing the spoken name or number to a directory stored in the computer readable memory; and
generating a VoIP call origination request message.

2. The wireless VoIP headset of claim 1, wherein the controller provides call control, messaging, capability exchange, and command signaling to implement Voice over Internet Protocol in accordance with Session Initiation Protocol.

3. The wireless VoIP headset of claim 2, wherein the VoIP call origination request message comprises a SIP INVITE message.

4. The wireless VoIP headset of claim 1, wherein the controller provides call control, messaging, capability exchange, and command signaling to implement Voice over Internet Protocol in accordance with the H.323 ITU-T specification, Simple Gateway Control Protocol (SGCP) or Internet Protocol Device Control (IPDC).

5. The wireless VoIP headset of claim 1, wherein encoding the digital audio signal comprises using pulse code modulation, linear pulse code modulation, iLBC, or ITU-T recommendations G.711. G.729, G.723, G.726, or G.722.

6. The wireless VoIP headset of claim 1, wherein the digital audio signal is transferred between the codec and the controller.

7. The wireless VoIP headset of claim 1, further comprising a plurality of web pages stored in the computer readable memory which may be served by the wireless VoIP headset.

8. The wireless VoIP headset of claim 7, wherein the plurality of web pages includes web pages associated with a telephone directory, volume control, audio filtering, signal processing control, or set up and provisioning information.

9. A wireless VoIP headset comprising:
a speaker;
a microphone for receiving speech energy from a near end user to generate an analog audio signal;
a codec for converting the analog audio signal to a digital audio signal and encoding the digital audio signal, wherein the codec also decodes a receive digital audio signal for output to the speaker;
a controller for processing the digital audio signal to generate IP packets and implementing a VoIP call control protocol;
an IEEE 802.11 transceiver;
a computer readable memory storing instructions that when executed by the controller cause the wireless VoIP headset to perform a method for originating a call comprising automatically connecting to a voice recognition server upon activation of the wireless VoIP headset by a user.

10. The wireless VoIP headset of claim 9, wherein the controller provides call control, messaging, capability exchange, and command signaling to implement Voice over Internet Protocol in accordance with Session Initiation Protocol.

11. The wireless VoIP headset of claim 9, wherein automatically connecting to a voice recognition server comprises sending a VoIP call origination request message to the voice recognition server.

12. The wireless VoIP headset of claim 11, wherein the VoIP call origination request message comprises a SIP INVITE message.

13. The wireless VoIP headset of claim 9, wherein the controller provides call control, messaging, capability exchange, and command signaling to implement Voice over Internet Protocol in accordance with the H.323 ITU-T specification, Simple Gateway Control Protocol (SGCP) or Internet Protocol Device Control (IPDC).

14. The wireless VoIP headset of claim 9, wherein encoding the digital audio signal comprises using pulse code modulation, linear pulse code modulation, iLBC, or ITU-T recommendations G.711. G.729, G.723, G.726, or G.722.

15. The wireless VoIP headset of claim 9, wherein the digital audio signal is transferred between the codec and the controller.

16. A VoIP telephone system comprising:
a computing device comprising:
a memory storing a name and phone number directory;
a first IEEE 802.11 transceiver;
a wireless VoIP headset comprising:
a second IEEE 802.11 transceiver;
a speaker;
a microphone for receiving speech energy from a near end user to generate an analog audio signal;
a codec for converting the analog audio signal to a digital audio signal and encoding the digital audio signal, wherein the codec also decodes a receive digital audio signal for output to the speaker;
a controller for processing the digital audio signal to generate IP packets and implementing a VoIP call control protocol;
a computer readable memory storing instructions that when executed by the controller cause the wireless VoIP headset to perform a method for originating a call comprising:
receiving a user directory selection from the computing device from the second IEEE 802.11 transceiver;
generating a VoIP call origination request message responsive to the user directory selection.

17. The VoIP telephone system of claim 16, wherein the controller provides call control, messaging, capability exchange, and command signaling to implement Voice over Internet Protocol in accordance with Session Initiation Protocol.

18. The VoIP telephone system of claim 16, wherein the VoIP call origination request message comprises a SIP INVITE message.

19. The VoIP telephone system of claim 16, wherein the controller provides call control, messaging, capability exchange, and command signaling to implement Voice over Internet Protocol in accordance with the H.323 ITU-T specification, Simple Gateway Control Protocol (SGCP) or Internet Protocol Device Control (IPDC).

20. The VoIP telephone system of claim 16, wherein encoding the digital audio signal comprises using pulse code modulation, linear pulse code modulation, iLBC, or ITU-T recommendations G.711. G.729, G.723, G.726, or G.722.

21. The VoIP telephone system of claim 16, wherein the digital audio signal is transferred between the codec and the controller.

22. A method for initiating a VoIP telephone call comprising:
providing a wireless VoIP headset comprising:
a speaker;
a microphone;
a codec;
a controller;
a first memory; and
a first IEEE 802.11 transceiver for wireless communications with an IEEE 802.11 access point;
providing a computing device comprising:
a second memory storing a name and phone number directory;
a second IEEE 802.11 transceiver for wireless communications with an IEEE 802.11 access point;
receiving a user selection at the computing device from the name and phone number directory;
transmitting the user selection from the computing device to the wireless VoIP headset via the IEEE 802.11 access point; and
generating a VoIP call origination request message at the wireless VoIP headset responsive to the user selection.

23. A method for initiating a VoIP telephone call comprising:
providing a wireless VoIP headset comprising:
a speaker;
a microphone;
a codec;
a controller;
a first memory; and
a first IEEE 802.11 transceiver for wireless communications with an IEEE 802.11 access point;
providing a computing device comprising:
a second memory storing a name and phone number directory;
a wired IEEE 802.3 network connection to the IEEE 802.11 access point;
receiving a user selection at the computing device from the name and phone number directory;
transmitting the user selection from the computing device to the wireless VoIP headset via the IEEE 802.11 access point; and
generating a VoIP call origination request message at the wireless VoIP headset responsive to the user selection.
